(19) United States
(12) Patent Application Publication
(10) Pub. No.: US 2014/0104436 A1
(43) Pub. Date: Apr. 17, 2014

(54) Circuit to adjust backlighting for a display device

(71) Applicant: Stephan Bork, Murphy, TX (US)

(72) Inventor: Stephan Bork, Murphy, TX (US)

(21) Appl. No.: 13/651,434

(22) Filed: Oct. 14, 2012

(51) Int. Cl. H04N 17/00

(52) U.S. Cl. CPC H04N 17/00
USPC 348/184

(57) ABSTRACT

A display device to measure ambient light brightness may include a camera to provide an image, a controller to detect a face from the image and to measure brightness from a ratio of the iris diameter to the pupil diameter D_{I}/D_{P}, and an actuator to stepwise change the backlighting of the display device based upon the measured brightness.

### FIELD OF THE INVENTION

The present invention relates to a backlight for a display device and more particularly for controlling the backlight based on a ratio of the iris diameter to the pupil diameter D_{I}/D_{P}.

### BACKGROUND

Today electronic devices like smartphones or tablet computers leverage a dedicated sensor to measure ambient light. The output of such ambient light sensors (ALS) is often used to adjust the back light of the display to save power (when there is a lot of ambient light the backlight has to be increased, where there is little ambient light the back light can be tuned down a bit).

An ambient light sensor is a sensor used to detect the amount of ambient light available for a given purpose. Small display devices 100 usually have a desired goal of saving power, and if there is adequate ambient light available for the user to see the display, power may be saved by cutting back or eliminating the amount of backlighting used for these display devices 100. However, when the ambient light is low, the amount of backlighting should he increased in order to allow the user to easily view the screen. However, the direction of the ambient light is also important. One of the best directions for ambient light is where the ambient light from the light source 103 (as seen in FIG. 2) is directed over the shoulder of the user directly onto the display device. Under these circumstances, the ambient light is directly shining on the display device 100, and the ambient light does not interfere with the user. One of the worst directions for the ambient light from a light source 103 (as shown in FIG. 1) is behind the display device 100 which may cast a shadow preventing the user from adequately seeing the display device

Under these circumstances, the ambient light does interfere with the user. Under both circumstances, the amount of ambient light may be the same, but the need for backlighting of the display device may be totally different. As a consequence, there is a need for a more accurate way to measure the need for backlighting of the display device.

Ambient-light sensor (ALS) ICs are increasingly used in a variety of display and lighting applications to save power and improve the user experience. With ALS solutions, system designers can automatically adjust display brightness based on the amount of ambient light, Since backlighting accounts for a significant portion of the system's power budget, dynamic brightness control can translate into substantial power savings. It can also improve the user experience, allowing screen brightness to be optimized based on ambient-light conditions.

Implementing such a system as shown in FIG. 3 requires three sections: a light sensor 105 to monitor the amount of ambient light, a device 107 (usually a microcontroller) to process the data, and an actuator 109 to control the current through the backlight 111.

The second part of this control scheme involves actuating changes in backlighting on the screen. This can be done in many ways, depending upon the screen module used in the application. Two of the simplest ways are directly via a pulse-width modulation (PWM) scheme or indirectly by using a screen controller chip.

Many display modules now have an integrated controller, which allows the user to directly set brightness by sending serial commands to the device. If this is not available, however, a simple backlight control actuator can be implemented by controlling the power delivered to a series of white LEDs behind the screen, which provide backlighting. One crude way of implementing this is by directly placing a FET in series with the LEDs and switching it on and off quickly using a PWM signal (FIG. 5).

It is best not to jump directly from one setting to another: rather, the backlight brightness should be ramped up and down smoothly to ensure a seamless transition between levels

This is best done by using timed interrupts with either a fixed or variable brightness step size to gradually shift either the PWM value used to control the current through the LEDs or the serial command sent to the display controller chip. FIG. 8 provides an example of such an algorithm. The prior art is limited since the ambient light sensor senses the light falling on the sensor, not the ambient light that shines in the users eye. Also the prior art requires a dedicated sensor hardware that adds cost to the electronic device.

U.S. Pat. No. 7,796,784 discloses a plurality of iris codes being registered for each registrant in an iris database together with pupil diameter-iris diameter ratio R. At the time of authentication, an iris code is obtained from a captured iris image by feature extraction while pupil diameter-iris diameter ratio R is obtained. Ratio R obtained at the time of registration and ratio R obtained at the time of authentication are compared to specify an appropriate iris code from the iris database as an item to be collated before authentication.

U.S. Pat. No. 7,076,087 discloses that both a forehead and a cheek are made in close contact to an eye position fixing portion, and a space defined between a left eye and a pinhole is shielded from extraneous light. When light derived from a room lighting device is entered into a right eye, a diameter of a pupil of the left eye is defined in a self-definition manner due to an interlocking characteristic of a living body, and then, a width of an iris 3 may be secured under stable condition. While infrared light is illuminated from a button lighting device onto this left eye, this illuminated left eye is photographed by an image pick up unit, and then, feature information as to the photographed left eye is compared with registered feature information in an individual identifying unit so as to execute an individual identification operation.

US patent application 20030012413 discloses iris identification apparatus for performing personal identification by way of a shot iris image, and a plurality of images are shot by using a camera whose quantity of a visible light included in an illuminating light irradiated onto a person to be shot differs from each other. The presence of a variation in the pupil diameter in the plurality of iris images is determined by a pupil size comparison processor. In case a variation in the pupil diameter is determined, personal identification by an iris identification processor based on any one of the plurality of iris images. Preferably, light emitting diodes for emitting a green light as a source of a visible light are used.

US patent application 20030002714 discloses a forehead and a cheek being made in close contact to an eye position fixing portion, and a space defined between an eye and a pinhole is shielded from extraneous light, and an iris is illuminated by infrared light of a lighting device. At this time, since a pupil diameter is defined in a self-control manner by receiving visible light of another lighting device, and also, a width of the iris is secured under stable condition, this iris is focused via the pinhole onto an image pick up element so that the iris can be photographed. Then, the acquired feature information of the iris is compared with registered feature information in order to execute the individual identifying operation.

The above patents and patent applications are incorporated by reference in their entirety.

### SUMMARY

A display device to measure ambient light brightness may include a camera to provide an image, a controller to detect a face from the image and to measure brightness from a ratio of the iris diameter to the pupil diameter D_{I}/D_{P}, and an actuator to stepwise change the backlighting of the display device based upon the measured brightness.

The controller may turn off the display device if a face is not detected.

The measured brightness may be compared with respect to a predetermined brightness.

The actuator may change the backlighting of the display device if the measured brightness is more than two increments from the predetermined brightness.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a user of the present invention and a light source;

FIG. 2 illustrates a user of the present invention and a light source;

FIG. 3 illustrates a circuit diagram of the present invention;

FIG. 4 illustrates a display device with a front facing camera of the present invention;

FIG. 5 illustrates a circuit diagram of the present invention;

FIG. 6 illustrates a diagram of the operating system of the present invention;

FIG. 7 illustrates a graph of ambient light versus screen brightness;

FIG. 8 illustrates the measurement of ratio of the iris diameter to the pupil diameter D_{I}/D_{P} under low light conditions;

FIG. 9 illustrates the measurement of ratio of the iris diameter to the pupil diameter D_{I}/D_{P} under bright light conditions;

FIG. 10 illustrates a flowchart to turn on and turn off the screen of the display device of the present invention;

FIG. 11 illustrates a flowchart to adjust the brightness level of the display device of the present invention;

FIG. 12 illustrates a graph showing the relationship between the ratio of the iris diameter to the pupil diameter D_{I}/D_{P} and the desired brightness of the display device 100.

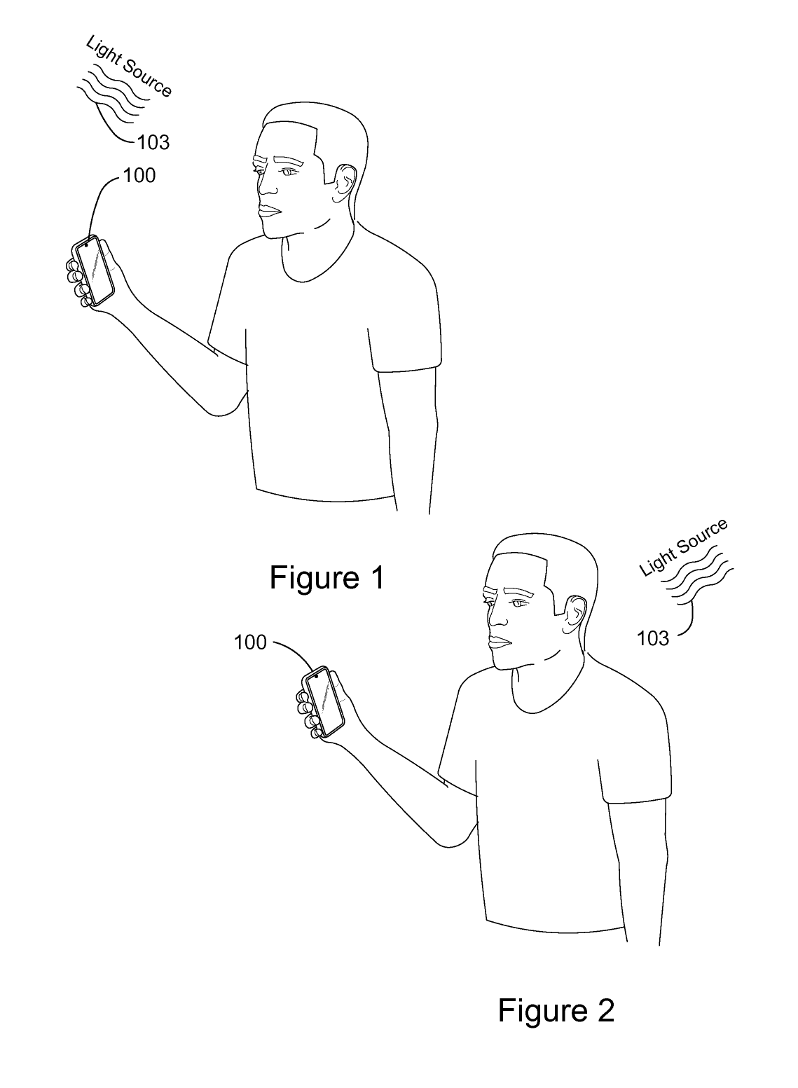

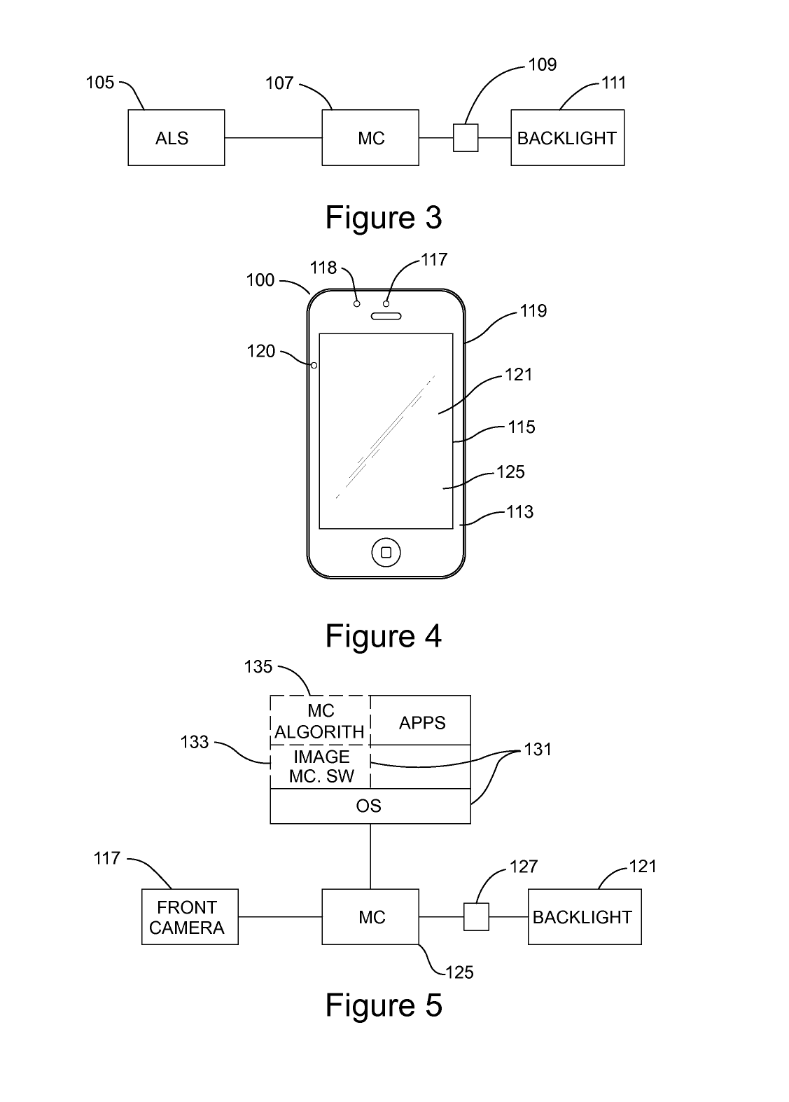

### DETAILED DESCRIPTION

FIG. 4 illustrates a display device 100 in accordance with the teachings of the present invention, and the display device 100 may include a front camera 117 which may be mounted on the front surface 119 of the display device 100 to provide images for the display device 100, a display 115 which may include a backlight 121 to backlight the display 115, a backlight actuator 123 to incrementally actuate the backlight 121, and a backlight controller 125 which may be a microcontroller to control the backlight actuator 123 by controlling the backlight actuator 127 which may incrementally (stepwise) increase or decrease the backlight 121. The display device 100 may be a cell phone, a PDA, a blackberry, a tablet or any other type of computing device.

FIG. 6 illustrates a schematic diagram of a portion of the software which may be controlled by the operating system (OS) 131 of the display device 100 and which may include an image microcontroller switch 133 to determine if a human face image is detected by the front camera 117 of the display device 101, an ALS algorithm 135 to determine the amount of backlighting which may be desired for backlighting 121 of the display 115.

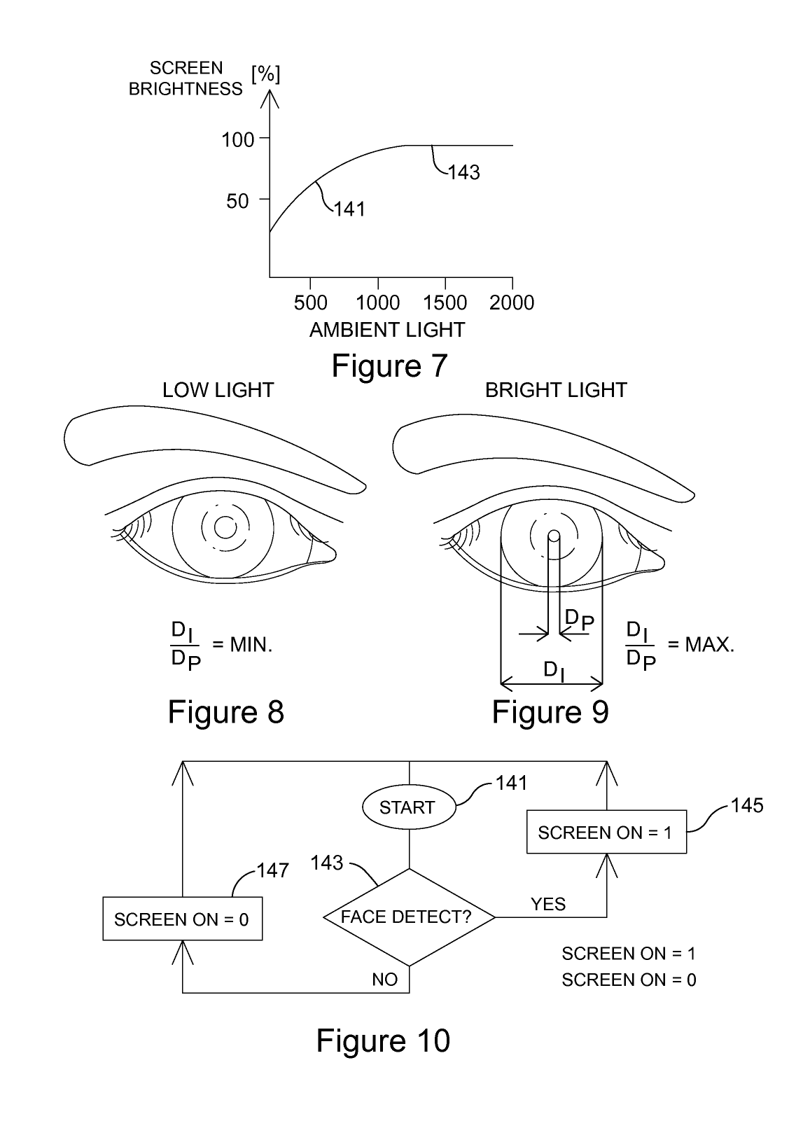

FIG. 7 illustrates the relationship between the ambient light versus the screen backlight (as a percent) and illustrates a substantially exponential portion 141 and a substantially linear portion 143.

FIG. 8 illustrates the calculation of the ratio of the iris diameter (D_{I}) to the pupil diameter (D_{P}) D_{I}/D_{P} which is proportional to the diameter of the retina with respect to the diameter of the pupil. Under low light conditions the ratio of the iris diameter to the pupil diameter D_{I}/D_{P} may be lower than the ratio of the iris diameter to the pupil diameter D_{I}/D_{P} under high (bright) light conditions.

FIG. 10 illustrates a flowchart for the image recognition switch software 133 and illustrates a start step 141. An image from the display 115 of the display device 100 is examined to determine if a face of a human for example the user has been detected in step 143. If a face has been detected, then in step 145, the backlight 121 is activated by the backlight activator 123 which is activated by the backlight controller 121. If no face has been detected, then in step 147, the backlight 121 remains off. In both step 145 and step 147, control returns to the start step 141.

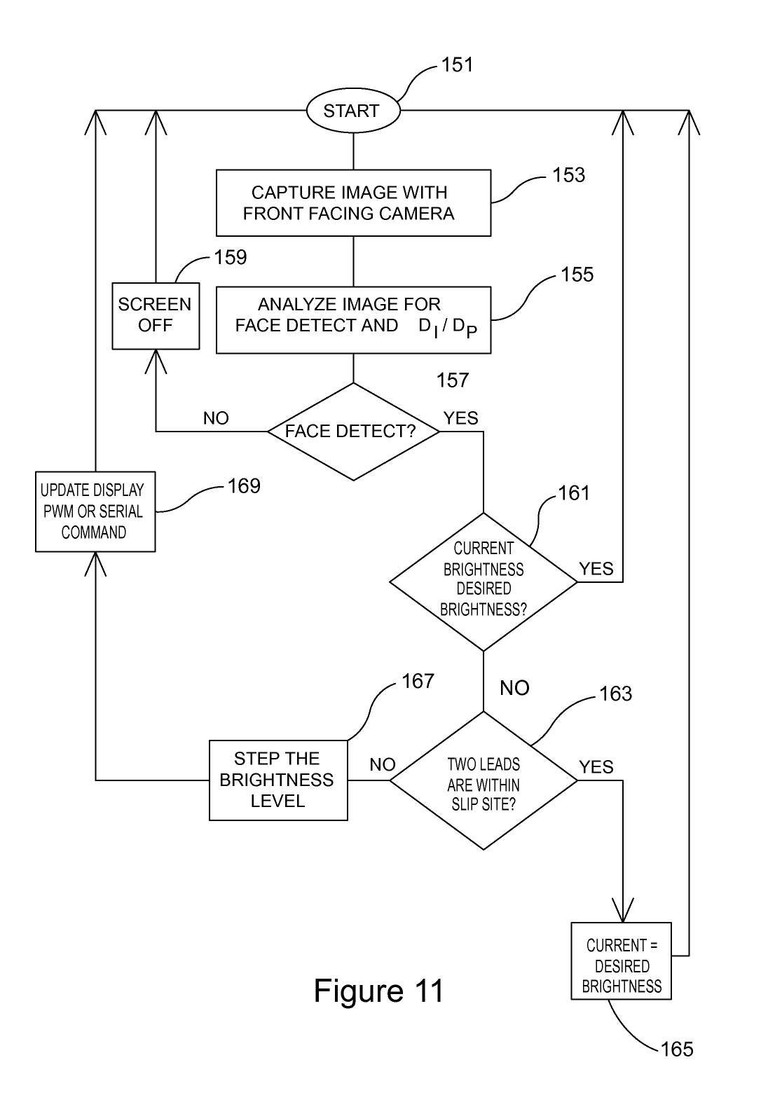

FIG. 11 illustrates the algorithm to determine the amount of adjustment for the backlight attenuator 127 which in turns adjust the backlight 121 of the display device 100. The algorithm starts at step 151 and control passes to step 153 where the front camera 117 of the display device 100 captures an image to be analyzed. Control passes to step 155 where the image is analyzed to determine if the face has been detected and the ratio of the iris diameter to the pupil diameter D_{I}/D_{P} if the face has been detected.

In step 157, if the face has not been detected from the image, control passes to step 159 to turn off the 115 of the display device 100, and control returns to step 151. If a face has been detected from the image, control passes to step 161 where the brightness from the ratio of the iris diameter to the pupil diameter D_{I}/D_{P} is compared with a desired or predetermined brightness. If the brightness from the ratio of the iris diameter to the pupil diameter D_{I}/D_{P} is substantially equal to the desired or predetermined brightness, control passes to step 151, and if the current brightness does not equal the desired brightness than the control passes to step 163. In step 163, the level of the current brightness is compared with the step size brightness which may be the amount that the backlight actuator 127 can change the backlight 121 by a single step. If the two levels are less than the step size, then control passes to step 165 where the current brightness is substantially equal to the desired brightness, and control passes to step 151.

If the two levels are not within a single step size, then control passes to step 167. In step 167 the backlight controller 125 controls the backlog actuator 127 to change the backlight 121 by the number of step sizes or increments determined by the comparison of the current brightness to the desired or predetermined brightness. The backlight controller 125 may raise or lower the brightness of the backlight 121 in accordance with if the current brightness is greater to or less than the desired or predetermined brightness.

In step 169, the display is updated by pulse width modulation PWM or serial commands to the backlog actuator 123. Control passes to step 151.

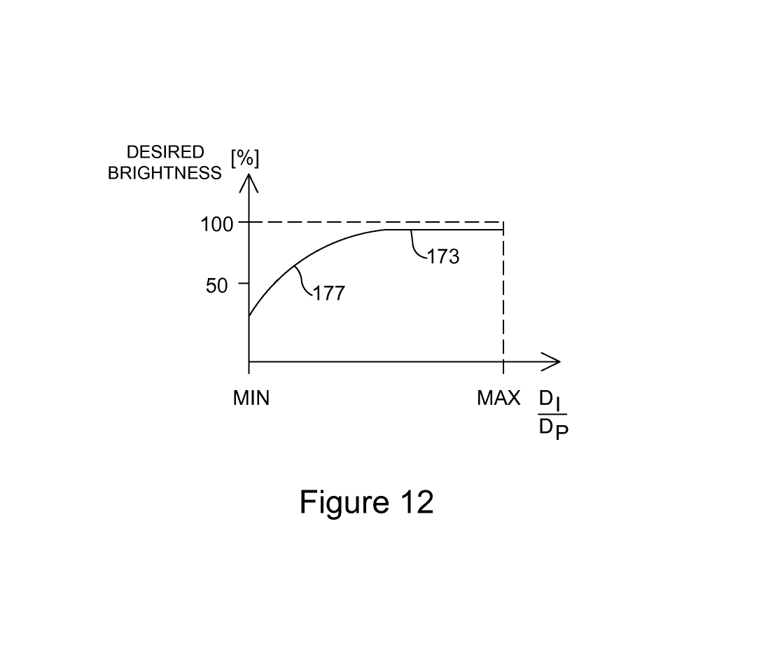

FIG. 12 illustrates the graph between the ratio of the iris diameter to the pupil diameter D_{I}/D_{P} and the desired brightness. FIG. 12 illustrates a curved portion 171 and a substantially linear portion 173.

In another embodiment, the controller 125 may determine that there are no eyes looking at the screen (when for example the phone is held to the ear to make a call) so that the backlight of the screen may be turned off immediately. The controller 125 could be enhanced when the camera would actually see the users side of the head. If a picture of the users side of the head and face is already stored in memory, the controller 125 may achieve a solution faster and may be more robust not to home in on other images that might look like a pair of eyes.

In another embodiment the controller 125 in the display device 100 can analyze discrepancies/differences between the ALS sensor output and the DI/DP ratio calculated by the controller 125 to gain more information about the user. For example certain drugs would make the pupil less sensitive to ambient light so the DI/DP ratio would be rather fixed than change with the ambient light changes which may be recognized by the hardware ALS. So the system could be implemented in a smartphone application and determine for example if a user had been using drugs and then the smartphone could notify for example the parents.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1-4.) (canceled)

5) A display device to measure ambient light brightness, comprising:
a camera to provide an image;
a controller to measure brightness from a ratio of the iris diameter to the pupil diameter D_{I}/D_{P};

6) A display device to measure ambient light brightness as in claim 5, wherein the controller turns off the display device if a face is not detected.

7) A display device to measure ambient light brightness as in claim 5, wherein the measured brightness is compared with respect to a predetermined brightness.

8) A display device to measure ambient light brightness as in claim 5, wherein the display device includes an actuator to stepwise change the backlighting of the display device based upon the measured brightness.

9) A display device to measure ambient light brightness as in claim 8, wherein the actuator changes the backlighting of the display device if the measured brightness is more than two increments from the predetermined brightness.

10) A display device to measure ambient light brightness as in claim 5, wherein the controller detects a face from the image.

11) A display device to measure ambient light brightness as in claim 5, wherein the display device includes an infrared light emitting diode light source and the camera is sensitive to the infrared light emitting diode light.

12) A display device to measure ambient light brightness as in claim 5, wherein the display device includes a ambient light sensor.

13) A display device to measure ambient light brightness as in claim 12, wherein the controller compares the brightness from the ambient light sensor and the brightness based upon the pupil diameter to determine if the pupil of the user is responsive to light.

14) A display device to measure ambient light brightness as in claim 13, wherein the controller activates the display device to transmit a signal when the comparison between the brightness from the ambient light sensor and the brightness based upon the pupil diameter exceeds a predetermined level.
